(19) United States
(12) Patent Application Publication
(10) Pub. No.: US 2015/0067055 A1
(43) Pub. Date: Mar. 5, 2015

(54) METHOD AND SYSTEM OF AN ANONYMOUS ONLINE SOCIAL NETWORK

(71) Applicants: Mandeep Khera, Fremont, CA (US); Manish Mehta, San Jose, CA (US)

(72) Inventors: Mandeep Khera, Fremont, CA (US); Manish Mehta, San Jose, CA (US)

(21) Appl. No.: 14/339,454

(22) Filed: Jul. 24, 2014

Related U.S. Application Data
(60) Provisional application No. 61/857,776, filed on Jul. 24, 2013.

(51) Int. Cl. H04L 29/06; H04L 29/08

(52) U.S. Cl. CPC H04L 63/0421; H04L 67/306
USPC 709/204

(57) ABSTRACT

In one exemplary aspect, a method of an anonymous online social network includes the step of providing an anonymous online social networking service. A user is enabled to create a user's anonymous profile on the anonymous online social networking service. The user's anonymous profile comprises a unique social number identifier. A user information is received by a server of the anonymous online social network. The user information includes an anonymous user interest and an anonymous attribute. A search functionality is provided wherein another user searches for the user's anonymous profile utilizing the anonymous user interest and the anonymous attribute. The unique social number identifier can be a user profile identified by a unique sequence of numbers such that the user's profile does not include personal identifying information about the user. The anonymous online social networking service can include a computing platform to build social networks and social relations among a set of users.

### CROSS-REFERENCE TO RELATED APPLICATIONS

This application is a claims priority from U.S. Provisional Application No. 61/857,776, titled A METHOD AND SYSTEM OF AN ANONYMOUS ONLINE SOCIAL NETWORK and filed Jul. 24, 2014. This application is hereby incorporated by reference in its entirety.

### BACKGROUND

There currently exist many types of online social networking services. Illustrative examples include Facebook®, Twitter® and Linkedin®. However, conventional methods of require a user to provide personal identifying information. Consequently, a user loses anonymity. Additionally, a user's real-world connections and online social networking connections often overlap. For example, a user of a non-anonymous online social networking service may receive ‘friend’ requests from social friends, relatives, work colleagues, etc. These connections can be based on real-world social relationships and not necessarily on the user's interests. At the same time, user may prefer to connect with others anonymously and based on common attributes. Furthermore, the carryover of real-world social network status into online social networking services allows for negative social experiences in the online social networking service. One example of this is the phenomenon of cyber bullying. A user may be able to create fake user profiles. However, in a non-anonymous online social networking service the expectation of other users is that the user's identity reflects a real person. Thus, valid and meaningful social connection may not be able to be made through fake user profiles.

Furthermore, some social groups may necessitate an anonymous online social networking service. For example, user may shy away from various online mutual aid groups, such as Alcoholics Anonymous, unless they can protect their identities. Anonymous identities may facilitate communication of personal experiences and honest assessments of one's shortcomings in an online group environment.

In view of this, improvements may be made over conventional methods if, for example, a user were able to remain anonymous while still maintaining a profile that reflects the user's real-world interests.

### BRIEF SUMMARY OF THE INVENTION

In one aspect, a method of an anonymous online social network includes the step of providing an anonymous online social networking service. A user is enabled to create a user's anonymous profile on the anonymous online social networking service. The user's anonymous profile comprises a unique social number identifier. A user information is received by a server of the anonymous online social network. The user information includes an anonymous user interest and an anonymous attribute. A search functionality is provided wherein another user searches for the user's anonymous profile utilizing the anonymous user interest and the anonymous attribute.

Optionally, the unique social number identifier can be a user profile identified by a unique sequence of numbers such that the user's profile does not include personal identifying information about the user. The anonymous online social networking service can include a computing platform to build social networks and social relations among a set of users. The anonymous user interest and the anonymous attribute can be used for providing targeted advertising to the user via the web site of the anonymous online social network. The user can generate and manage an online group web page within the web site of the anonymous online social network, and wherein the online group is based on the anonymous user interest.

### BRIEF DESCRIPTION OF THE DRAWINGS

The present application can be best understood by reference to the following description taken in conjunction with the accompanying figures, in which like parts may be referred to by like numerals.

FIG. 1 depicts a system of an anonymous social networking service, according to some embodiments.

FIG. 2 is a block diagram of a sample computing environment that can be utilized to implement some embodiments.

FIG. 3 illustrates hardware of a machine configured with processes according to some embodiments.

FIG. 4 illustrates an example flowchart of a process for implementing some embodiments.

FIG. 5 illustrates an example flowchart of a process for authenticating a user attempting to access an anonymous online social networking service, according to some embodiments.

FIG. 6 illustrates an example flowchart of a process for providing and joining a group in an anonymous online social networking service, according to some embodiments.

FIG. 7 illustrates an example mobile device application interface with information about the anonymous online social networking service, according to some embodiments.

FIG. 8 illustrates and example mobile device application interface with user input fields whereby a user can contact an anonymous online social networking service administrator and/or provide feedback, according to some embodiments.

FIG. 9 illustrates and example mobile device application interface with user input fields whereby a user can provide comments, according to some embodiments.

FIG. 10 illustrates and example mobile device application interface with a side menu whereby a user can join groups including other users identified by a social number.

FIG. 11 illustrates and example mobile device application interface with a view of the recommended groups screen after a user clicks from the side menu.

FIG. 12 illustrates and example mobile device application interface with a view of the recommended pals page linked to from the side menu.

FIG. 13 illustrates a method of anonymous online virtual community, according to some embodiments.

The Figures described above are a representative set, and are not an exhaustive with respect to embodying the invention.

### DESCRIPTION

Disclosed are a system, method, and article of manufacture of an anonymous online social network, according to some embodiments. The following description is presented to enable a person of ordinary skill in the art to make and use the various embodiments. Descriptions of specific devices, techniques, and applications are provided only as examples. Various modifications to the examples described herein may be readily apparent to those of ordinary skill in the art, and the general principles defined herein may be applied to other examples and applications without departing from the spirit and scope of the various embodiments.

Reference throughout this specification to “one embodiment,” “an embodiment,” “one example,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant an can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Exemplary Environment and Architecture

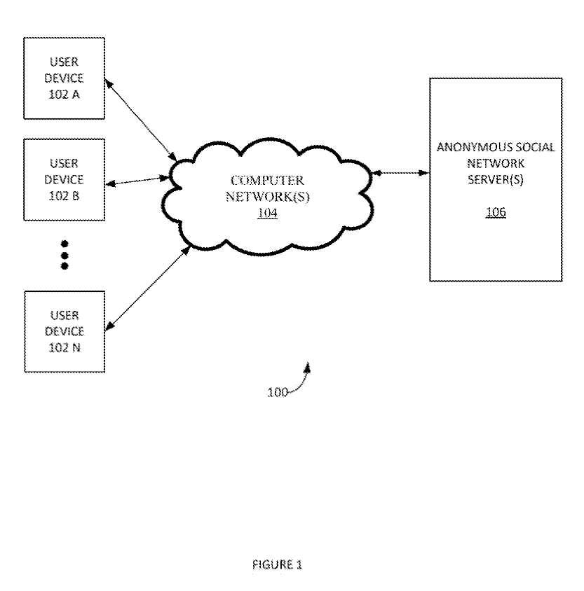

FIG. 1 depicts a system 100 of an anonymous social networking service, according to some embodiments. System 100 can include user devices 102 A-N. User devices 102 A-N can enable a user to communicate with anonymous social network server(s) 106 via computer network(s) 104. User devices 102 A-N can include various types of user-side computing systems such as smart phones, tablet computers, lap tops, PC-type computers, and the like. User devices 102 A-N can include web browsers for retrieving, presenting, and traversing information resources on the World Wide Web. Thus, various users/members of anonymous social network can utilize user devices 102 A-N to access anonymous social network in order to interact with each other as well as other features of the anonymous social network.

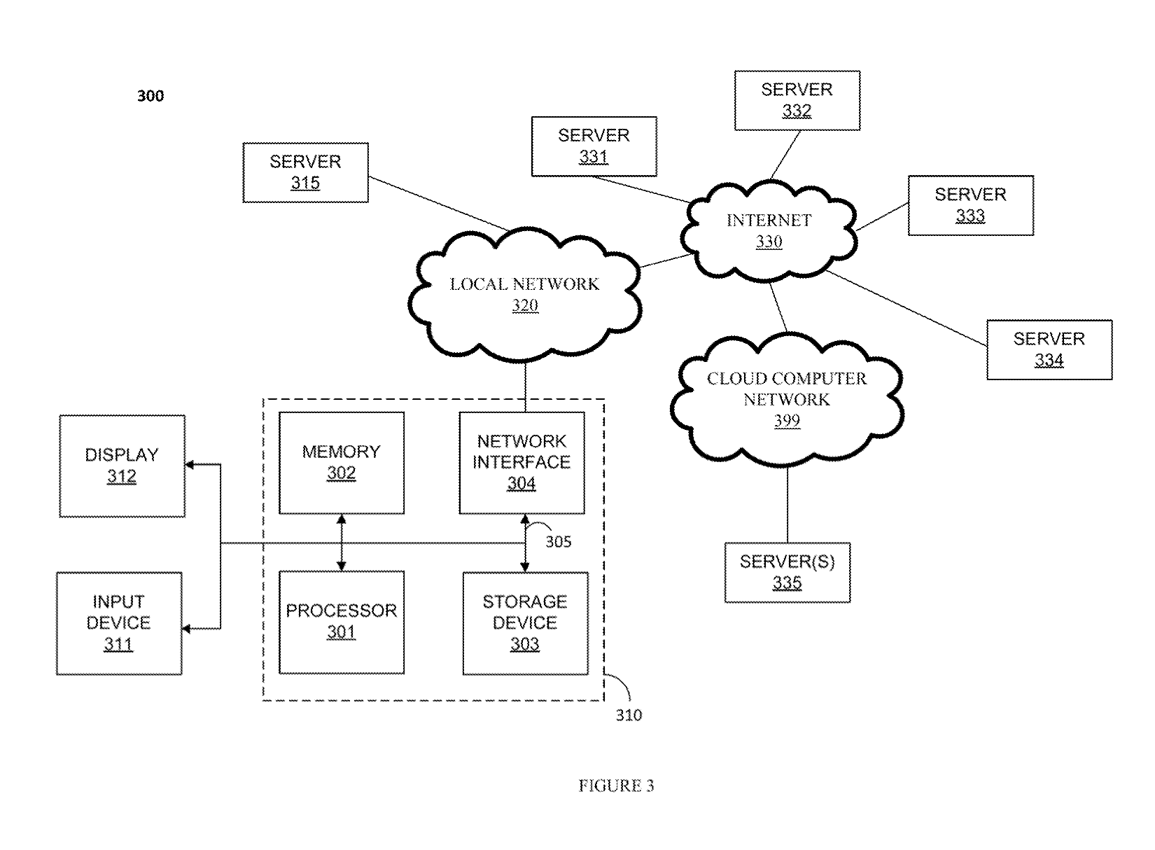

Computer network(s) 104 can a collection of computers and other hardware components interconnected by communication channels that allow sharing of resources and information (e.g. local area network (LAN), Internet, digital cellular network, etc.). Anonymous social network server(s) 106 can be implemented in various arrangements including a cloud-computing system (see e.g. FIG. 3). Additional examples of various types of computer network(s) 104 are provided infra in the description of FIG. 3. Anonymous social network server(s) 106 can provide an online social network. An example online social network can include an online service, platform, or site that focuses on facilitating the building of social networks and/or social relations among people who, for example, share interests, activities, backgrounds, or real-life connections. A social network service can consist of an anonymous representation of each user (e.g. a profile represented by a social number), his/her social links, and a variety of additional services. Social network services can be web-based and provide means for users to interact over the Internet, such as e-mail, status updates, microblog posts, posting of media content (e.g. digital images, audio content and/or video content) and/or instant messaging. Anonymous social network server(s) 106 can enable users to anonymously share ideas, activities, events, and interests within their individual networks. These activities can be associated with a social number and not a user's individual name and/or other information that can be utilized to identify the user (e.g. address, IP address, and the like). The user level can thus consist of an anonymous set of nodes identifiable by a social number. It is noted that a user can display his/her social number is a variety of settings such as on business cards, clothing, email tags, and the like. In this way, people can exchange social numbers in real world settings in a manner that may seem awkward with other social networking identifiers (e.g. avatar names, personal names, etc.)

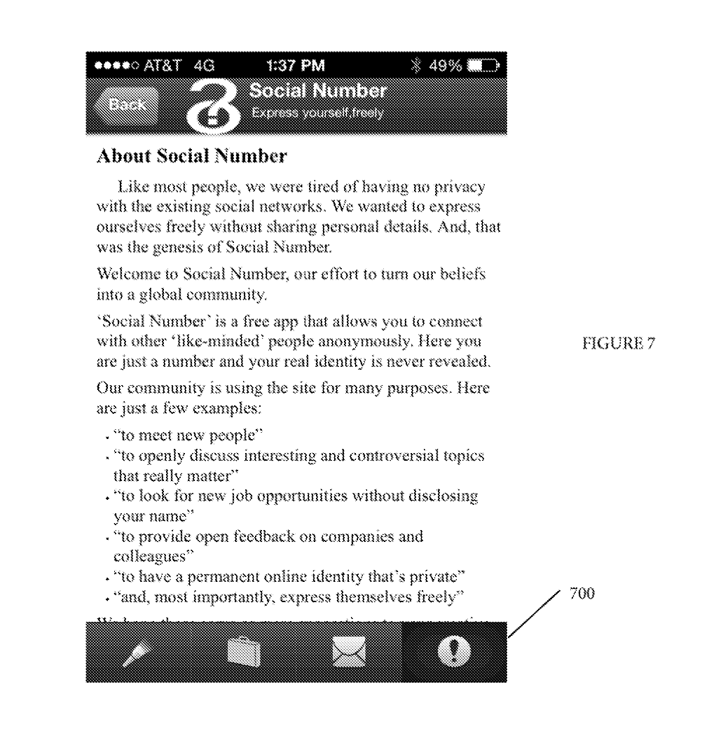

For example, a user's visible profile can be identified by a ‘social number’ (e.g. a unique sequence of numbers). Additionally, a list of “friends” (e.g. explicit social network connections between the user and other users of the anonymous social networking service) can be provided on the user's profile page—however, the friends can also be identified through their own unique ‘social numbers’. It is noted that a user's visible profile can include personal information about the user. Some visible information can be generated from answers to questions, such as age, location, interests, etc. In some embodiments, a user can also upload pictures, add multimedia content or modify the look and feel of the profile. Users can also perform other operations such as post blog entries, search for others with similar interests and compile and/or share lists of contacts. User profiles often have a section dedicated to comments from friends and other users. To protect user privacy, the anonymous social networking service can also include controls that allow users to choose who can view their profile, contact them, add them to their list of contacts, and so on. Moreover, the social networking service can include additional features, such as the ability to create groups that share common interests or affiliations, upload or stream live videos, and hold discussions in forums. It is noted that, regardless of the operation performed by the user, the user will remain identified by the associated social number and not a personal name. See FIGS. 7-25 for various user-profile examples and other use cases of the anonymous social networking service.

In some example embodiments, the social number can be randomly generated by a functionality of anonymous social network server(s) 106 and used to identify a user's account. In other example embodiments, the social number can be chosen (in whole and/or in part) by a user. The anonymous social network service can retain some social numbers as unavailable to members. In some embodiments, members can manually generate social numbers with various mnemonic-friendly formats. For example, each single integer can be mapped to three letters just like on a telephone pad. Therefore, the member can type in any ASCII string and the anonymous social network server(s) 106 can convert the string to the corresponding social number.

A distinction between user anonymity (e.g. access to a user's true identity) and user privacy (e.g. access by other users to user profiles and user information such as interests, group memberships, uploads, etc.) can be provided. User anonymity can be protected by only associating the user with a social number. Anonymous social network server(s) 106 can utilize various security techniques to ensure anonymity within the anonymous social networking service. For example, anonymous social network server(s) 106 can utilize a separate server(s) for mapping emails to social numbers. In other words, user email addresses can be maintained on separate servers so the anonymous nature of the site is maintained. User messages, microblog posts, and/or emails can be communicated to a secure server for transmission outside of anonymous social network server(s) 106 to other user devices 102 A-N in order to preserve the anonymity of the sending user. In another example, on publically accessible servers, only social number and associated user information can be stored.

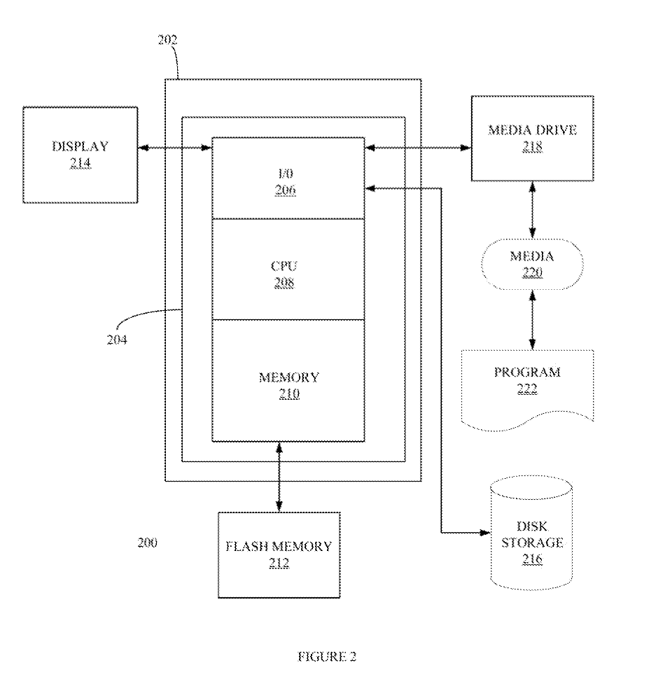

FIG. 2 depicts an exemplary computing system 200 that can be configured to perform any one of the processes provided herein. In this context, computing system 200 may include, for example, a processor, memory, storage, and I/O devices (e.g., monitor, keyboard, disk drive, Internet connection, etc.). However, computing system 200 may include circuitry or other specialized hardware for carrying out some or all aspects of the processes. In some operational settings, computing system 200 may be configured as a system that includes one or more units, each of which is configured to carry out some aspects of the processes either in software, hardware, or some combination thereof.

FIG. 2 depicts computing system 200 with a number of components that may be used to perform any of the processes described herein. The main system 202 includes a motherboard 204 having an I/O section 206, one or more central processing units (CPU) 208, and a memory section 210, which may have a flash memory card 212 related to it. The I/O section 206 can be connected to a display 214, a keyboard and/or other user input (not shown), a disk storage unit 216, and a media drive unit 218. The media drive unit 218 can read/write a computer-readable medium 220, which can contain programs 222 and/or data. Computing system 200 can include a web browser. Moreover, it is noted that computing system 200 can be configured to include additional systems in order to fulfill various functionalities. In some embodiments, system 200 can be included and/or be utilized by the various systems and/or methods described herein.

FIG. 3 illustrates hardware of a machine configured with processes according to some embodiments. As mentioned above, the computer systems and software servers on a local network may communicate with each other and other computer systems and servers running instances of programs on a cloud computer system. An example computer system 310 is illustrated in FIG. 3. Computer system 310 includes a bus 305 or other communication mechanism for communicating information, and a processor 301 coupled with bus 305 for processing information. Computer system 310 also includes a memory 302 coupled to bus 305 for storing information and instructions to be executed by processor 301, including information and instructions for performing the techniques described above, for example. This memory may also be used for storing variables or other intermediate information during execution of instructions to be executed by processor 301. Possible implementations of this memory may be, but are not limited to, random access memory (RAM), read only memory (ROM), or both. A storage device 303 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 303 may include source code, binary code, or software files for performing the techniques above, for example. Storage device and memory are both examples of computer readable mediums. Computer system 310 may be coupled via bus 305 to a display 312, such as a cathode ray tube (CRT) or liquid crystal display (LCD), for displaying information to a computer user. An input device 311 such as a keyboard and/or mouse is coupled to bus 305 for communicating information and command selections from the user to processor 301. The combination of these components allows the user to communicate with the system. In some systems, bus 305 may be divided into multiple specialized buses. Computer system 310 also includes a network interface 304 coupled with bus 305. Network interface 304 may provide two-way data communication between computer system 310 and the local network 320. The network interface 304 maybe a digital subscriber line (DSL) or a modem to provide data communication connection over a telephone line, for example. Another example of the network interface is a local area network (LAN) card to provide a data communication connection to a compatible LAN. Wireless links are another example. In any such implementation, network interface 304 sends and receives electrical, electromagnetic, or optical signals that carry digital data streams representing various types of information.

Computer system 310 can send and receive information, including messages or other interface actions, through the network interface 304 across a local network 320, an Intranet, or the Internet 330. For a local network, computer system 310 may communicate with a plurality of other computer machines, such as server 315 one or more of which may run backend system software such as an ERP software system, CRM, or database for example. Accordingly, computer system 310 and server computer systems represented by server 315 may form a local network, which may be programmed with processes described herein. In the Internet example, software components or services executing on computer system in the local network may communicate with computer programs on a cloud network 1099 across the Internet. Communications with program on the Internet may include communication with programs residing on multiple different computer systems 310 or servers 331-335 across the network. Servers 331-335 can include e-mail servers, IM servers, media content provider servers, and the like. The processes described above may be implemented for communication with programs implemented on one or more servers, for example. A server 335 on cloud 399, for example, may transmit messages through Internet 330, local network 320, and network interface 304 to a component on computer system 310. The software components and processes described above may be implemented on any computer system and send and/or receive information between networks as set forth above, for example.

Exemplary Processes and Use Cases

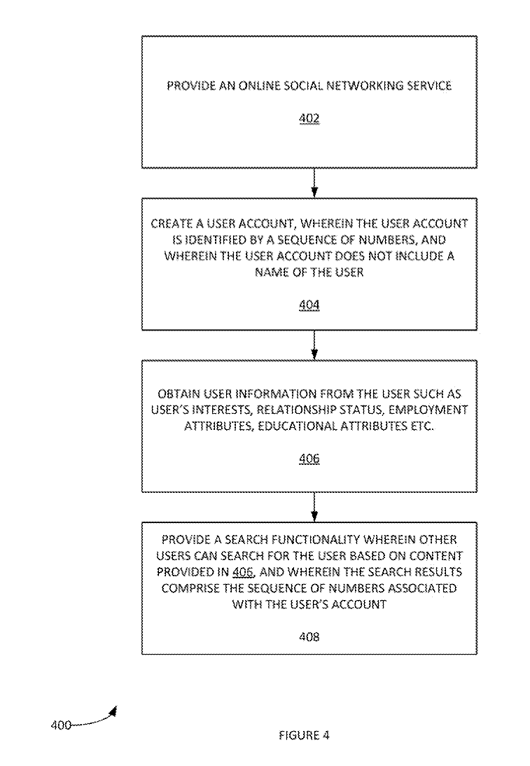

FIG. 4 illustrates an example flowchart of a process 400 for implementing some embodiments. In step 402 of process 400, an anonymous online social networking service is provided. For example, the online social networking service can be provided by anonymous social networking server(s) 106 as described supra. In step 404, a user can create an account on the anonymous online social networking service. The account can include a user's profile. The user's profile can be identified by a unique sequence of numbers (e.g. a social number). In this way, the user's account information and/or the user's profile does not include personal identifying information about the user such as the user's name. In step 406, other information about the user can be obtained. This information can be utilized by the anonymous online social networking service for various services such as recommending other connections to other user's identified by social numbers, available applications and activities, user groups, etc. This information can also be included in a user's profile web page. In step 408, a search functionality can be provided by the anonymous online social networking service. The search functionality can allow users to search for other users based on various factors such user's profile information, interests, activities, group memberships, and the like.

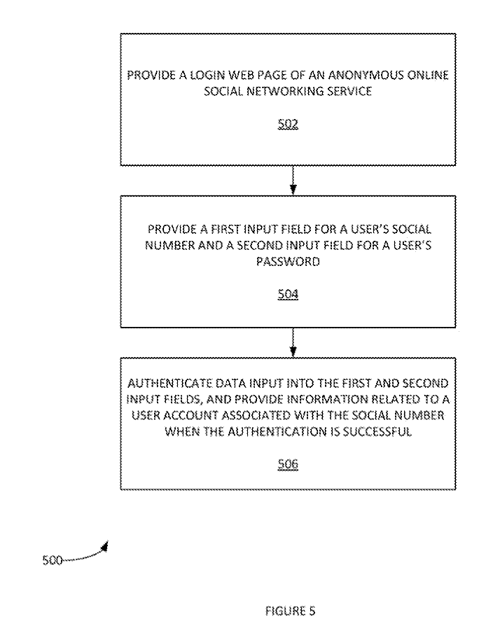

FIG. 5 illustrates an example flowchart of a process 500 for authenticating a user attempting to access an anonymous online social networking service, according to some embodiments. In step 502, a login webpage of an anonymous online social networking service is provided. In step 504, a first input field is provided. The web page can include text indicating that the user input a social number. A second input field can be provided. The web page can include text indicating that the user input a password associated with the social number. In step 506, the data input into the first and second fields is authenticated (e.g. with an authentication protocol). The user can then access various functionalities and web pages (e.g. the user's profile web page, connection's profile web pages, etc.) of the anonymous online social networking service. A user can also modify various attributes of the user's account once the user has completed process 500. In some embodiments, process 500 can be implemented by anonymous social network server(s) 106.

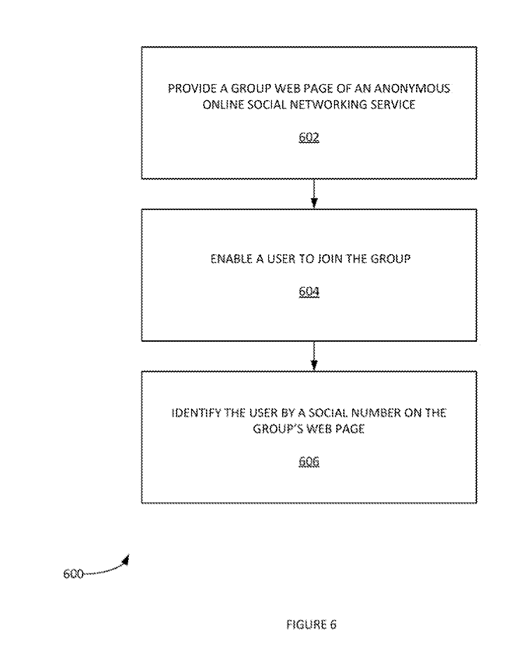

FIG. 6 illustrates an example flowchart of a process 600 for providing and joining a group in an anonymous online social networking service, according to some embodiments. As used herein, a group (e.g. a community, e-group or club) can be a feature in the anonymous online social network service which allows users to create, post, comment to and read from their own interest- and niche-specific forums, often within the realm of virtual communities. A group can allow for open or closed access, invitation and/or joining by other users outside the group. A group can be formed to provide mini-networks within the larger, more diverse social network service. A group can be owned and maintained by users (e.g. owners, moderators, and/or managers) which possess the capability of editing posts to discussion threads and regulating member behavior within the group. In step 602, a group web page is provided by the anonymous online social networking service. Attributes group web page (e.g. subject matter, graphical display design, user permissions, and the like) can be designed by the group's originating user(s). In step 604, a user is enabled to join the group. The method of joining can be set by the group's originating user(s). For example, some groups can be by invitation and others may be open to any user-member of anonymous online social networking service. In step 606, a group-member user is identified to the rest of the group on the group's web page by the user's social number. The user's social number can also be associated with various other information about the user such as user's image, demographic information, interests, etc. As noted supra, examples of groups can include online mutual aid organizations such Alcoholics Anonymous, Narcotics Anonymous and the like.

Furthermore, the anonymous online social networking service can utilize member information to target advertisements to the user. For example, explicit interests indicated by the users in their profiles can be used for targeted advertising on the anonymous online social networking website.

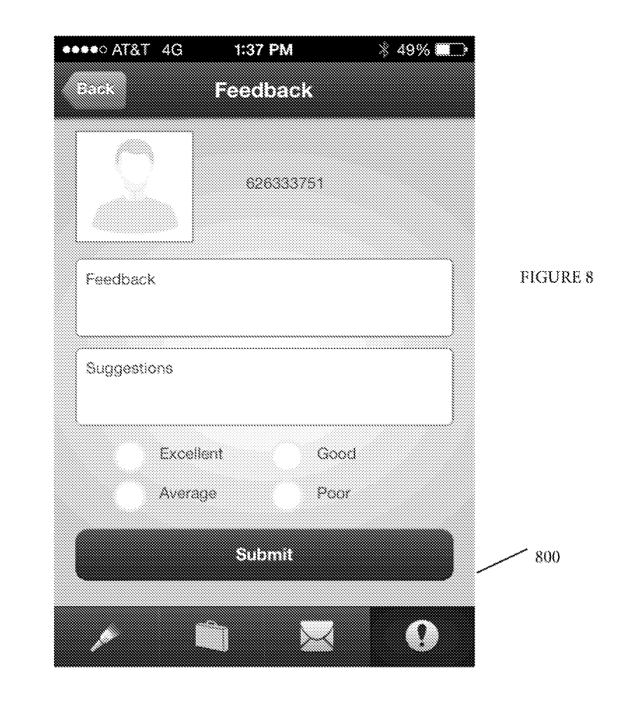

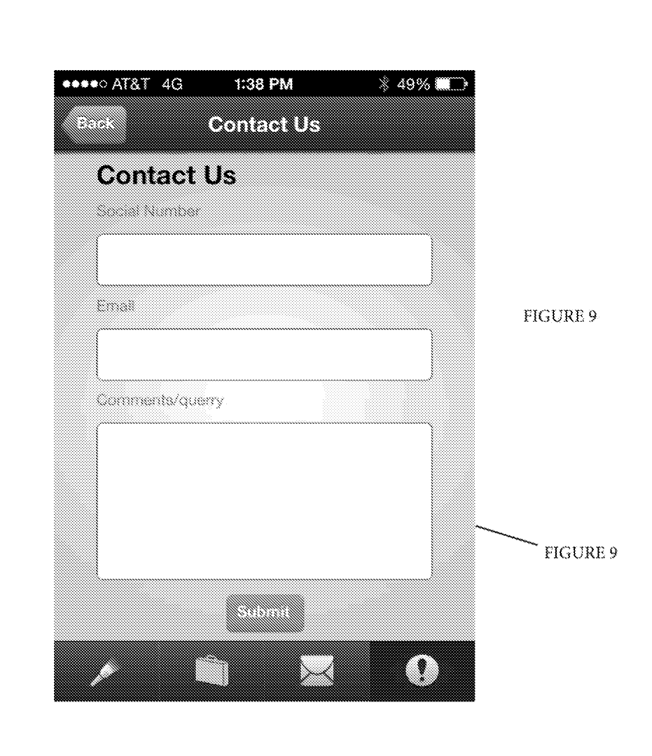

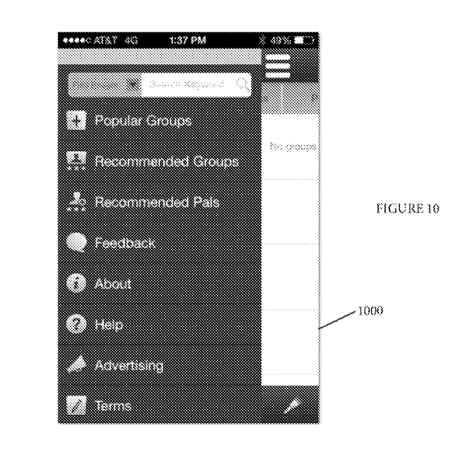

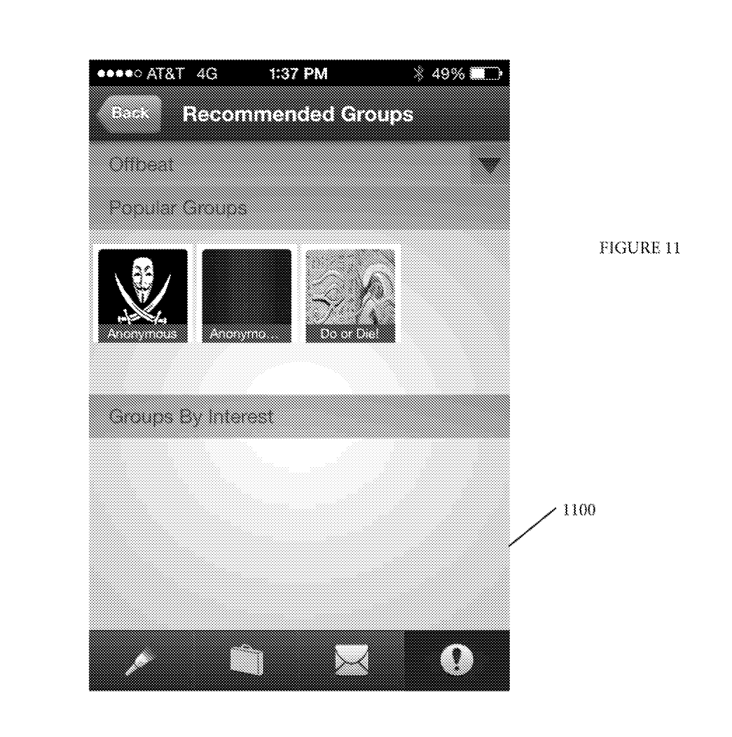

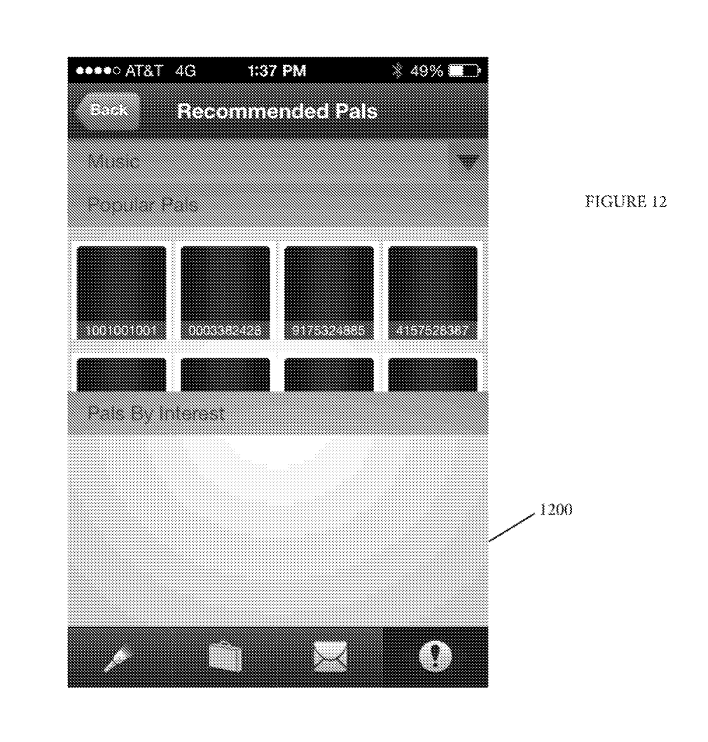

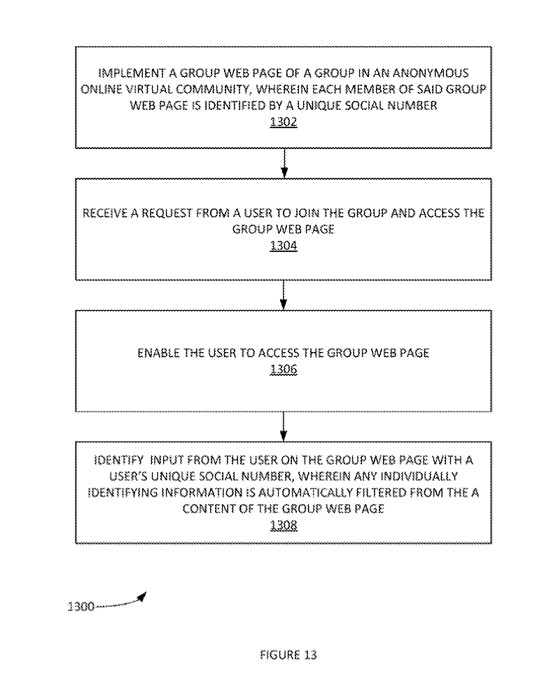

FIGS. 7-12 provide various example screen shots of an anonymous online social networking service on a mobile device interface, according to some embodiments. The systems and methods of FIGS. 1-6 and/or FIG. 13 can be utilized to develop and deploy the anonymous online social networking service depicting in FIGS. 7-12. More specifically, FIG. 7 illustrates an example mobile device application interface 700 with information about the anonymous online social networking service. FIG. 8 illustrates and example mobile device application interface 800 with user input fields whereby a user can contact an anonymous online social networking service administrator and/or provide feedback. FIG. 9 illustrates and example mobile device application interface 900 with user input fields whereby a user can provide comments. FIG. 10 illustrates and example mobile device application interface 1000 with a side menu whereby a user can join groups including other users identified by a social number. FIG. 11 illustrates and example mobile device application interface 1100 with a view of the recommended groups screen after a user clicks from the side menu. FIG. 12 illustrates and example mobile device application interface 1200 with a view of the ‘recommended pals’ page linked to from the side menu. It is noted that the ‘pals’ on the ‘recommended pals’ page are identified by an anonymous social number. Various other embodiments are not limited by the depictions of the examples of FIGS. 7-12.

FIG. 13 illustrates a method of anonymous online virtual community, according to some embodiments. In step 1302, a group web page of a group in an anonymous online virtual community can be implemented (e.g. published via a web server). Each member of said group web page can be identified by a unique social number on the group web page. In step 1304, a request from a user to join the group and access the group web page can be received. In step 1306, the user can be enabled to access (e.g. download a current version of the web page, post anonymous content to the web page, etc.). The group web page. In step 1308, input from the user on the group web page can be identified with a user's unique social number. The online virtual community web servers can automatically filter any individually identifying information from the content of the group web page.

At least some values based on the results of the above-described processes can be saved for subsequent use. Additionally, a computer-readable medium can be used to store (e.g., tangibly embody) one or more computer programs for performing any one of the above-described processes by means of a computer. The computer program may be written, for example, in a general-purpose programming language (e.g., Pascal, C, C++, Java, Python) and/or some specialized application-specific language (PHP, Java Script, XML).

B. Conclusion

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it will be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A method of an anonymous online social network comprising:
providing an anonymous online social networking service;
enabling a user to create a user's anonymous profile on the anonymous online social networking service, wherein the user's anonymous profile comprises a unique social number identifier;
receiving a user information, wherein the user information comprises an anonymous user interest and an anonymous attribute; and
providing a search functionality wherein another user searches for the user's anonymous profile utilizing the anonymous user interest and the anonymous attribute.

2. The method of claim 1, wherein the unique social number identifier comprises a user profile identified by a unique sequence of numbers such that the user's profile does not include personal identifying information about the user.

3. The method of claim 2, wherein the anonymous online social networking service comprises a computing platform to build social networks and social relations among a set of users.

4. The method of claim 3 further comprising:
including the anonymous user interest and the anonymous attribute in a user profile web page available via a web site of the anonymous online social network.

5. The method of claim 4, wherein the anonymous user interest and the anonymous attribute are used for providing targeted advertising to the user via the web site of the anonymous online social network.

6. The method of claim 5, wherein the user generates an online group web page within the web site of the anonymous online social network, and wherein the online group is based on the anonymous user interest.

7. A computerized system of an anonymous online social network comprising:
a processor configured to execute instructions;
a memory containing instructions when executed on the processor, causes the processor to perform operations that:
detect a change to the number of database nodes a database cluster;
implement consensus-based voting process utilizing all of a set of database nodes in the database cluster;
provide an anonymous online social networking service;
enable a user to create a user's anonymous profile on the anonymous online social networking service, wherein the user's anonymous profile comprises a unique social number identifier;
receive a user information, wherein the user information comprises an anonymous user interest and an anonymous attribute; and
provide a search functionality wherein another user searches for the user's anonymous profile utilizing the anonymous user interest and the anonymous attribute.

8. The computerized system of claim 7, wherein the unique social number identifier comprises a user profile identified by a unique sequence of numbers such that the user's profile does not include personal identifying information about the user.

9. The computerized system of claim 8, wherein the anonymous online social networking service comprises a computing platform to build social networks and social relations among a set of users.

10. The computerized system of claim 9, wherein the memory containing instructions when executed on the processor, causes the processor to perform operations that:
include the anonymous user interest and the anonymous attribute in a user profile web page available via a web site of the anonymous online social network.

11. The computerized system of claim 10, wherein the anonymous user interest and the anonymous attribute are used for providing targeted advertising to the user via the web site of the anonymous online social network.

12. The computerized system of claim 11, wherein the user generates an online group web page within the web site of the anonymous online social network, and wherein the online group is based on the anonymous user interest.

13. A method of an anonymous online virtual community comprises:
implementing a group web page of a group in an anonymous online virtual community, wherein each member of said group web page is identified by a unique social number;
receiving a request from a user to join the group and access the group web page;
enabling the user to access the group web page;
identifying input from the user on the group web page with a user's unique social number, wherein any individually identifying information is automatically filtered from the a content of the group web page.

14. The method of the anonymous online virtual community of claim 13, wherein the user's unique social number comprises a unique sequence of numbers or symbols.

15. The method of the anonymous online virtual community of claim 14, wherein only the user's unique social number and other associated anonymous user information is stored in any publically accessible server of the anonymous online virtual community.
